(19) United States
(12) Patent Application Publication
(10) Pub. No.: US 2012/0148880 A1
(43) Pub. Date: Jun. 14, 2012

(54) METHOD FOR OPERATING A BATTERY

(75) Inventors: Tim Schaefer, Niedersachswerfen (DE); Andreas Gutsch, Luedinghausen (DE); Claus-Rupert Hohenthanner, Hanau (DE)

(73) Assignee: LI-TEC BATTERY GMBH, Kamenz (DE)

(21) Appl. No.: 13/265,239

(22) PCT Filed: Apr. 20, 2010
(86) PCT No.: PCT/EP10/02413

§ 371 Date: Mar. 2, 2012

(30) Foreign Application Priority Data
Apr. 20, 2009 (DE) 10 2009 018 079.6

(51) Int. Cl. H01M 10/42; H01M 10/48

(52) U.S. Cl. 429/50; 429/90

(57) ABSTRACT

The task at hand is achieved by a method for operating a battery having at least one galvanic cell. The at least one galvanic cell is subjected at least temporally to an examination, particularly at a predetermined operating state of the battery or the galvanic cell.

Priority application DE 10 2009 018 079.6 is fully incorporated by reference into the present application.

The present invention relates to a method for operating a battery. The invention is described in connection with lithium ion batteries for supplying motor vehicle drives. It is pointed out that the invention can also find application independently of the chemistry of the battery, its design or independently of the type of supplied drive.

Batteries with a plurality of galvanic cells for supplying motor vehicle drives are known from the prior art. Some designs have in common the fact that they release the stored energy potentially in an uncontrolled way, especially after a minimum operating period.

The problem underlying the invention is for the most part to obtain the operational reliability of a battery also after a minimum operating period.

According to the invention, this is achieved by the teaching of the independent claims. Preferred developments of the invention are the subject-matter of the sub-claims.

The problem underlying the invention is solved by a method for operating a battery with at least one galvanic cell. The at least one galvanic cell is subjected at least temporarily to an examination, in particular in a predetermined operating state of the battery or the galvanic cell. The examination of the at least one galvanic cell takes place with a non-destructive testing method, wherein at least one test result is made available. The at least one test result is then linked to at least a first comparative value.

Within the meaning of the invention, a battery is understood to mean a device with at least one galvanic cell for supplying a drive. Preferably, the battery comprises a plurality of galvanic cells, which are connected to one another electrically. The battery preferably comprises further devices, which assist the correct operation of the at least one galvanic cell. The battery is rechargeable, depending on the design of the at least one galvanic cell. One then also speaks of a storage battery or a secondary battery.

Within the meaning of the invention, a galvanic cell is understood to mean a device which is used to deliver electric energy. The galvanic cell stores the energy in chemical form. The chemical energy is converted before delivery of an electric current. The galvanic cell is also potentially suitable for absorbing electric energy, converting it into chemical energy and storing it. In order to store the energy, the galvanic cell comprises at least two electrodes of differing polarity, i.e. an anode and a cathode, and an electrolyte. The galvanic cell preferably further comprises a separator which electrically insulates two electrodes of differing polarity and spaces the latter apart from one another. The electrodes are preferably disposed in an electrode stack. The galvanic cell preferably comprises a jacket, which at least partially surrounds the electrodes. The jacket is preferably constituted by a composite foil and/or a thin-walled metal.

Within the meaning of the invention, examination is understood to mean a process in which a parameter, state and/or transition from a first state to a second state is ascertained. An examination preferably takes place when required. An examination preferably delivers an electronically processable result.

Within the meaning of the invention, an operating state is understood to mean the state of a device, wherein a state can be described by a series of physical parameters. In order to determine an operating state, at least one physical parameter of the device is preferably determined, particularly preferably together with the time of the determination. The nature of the at least one physical parameter is selected such that a knowledge thereof enables information to be acquired about the state of the device. An operating state is preferably determined by a plurality of measured physical parameters. It is not uncommon to split up various operating states of a device into desirable, undesirable and dangerous operating states.

Within the meaning of the invention, a non-destructive testing method is a method for examining a device. The effect of a non-destructive testing method is that the tested or examined device is impaired as little as possible, preferably not impaired, in terms of its functioning capacity. The non-destructive testing method is preferably carried out during the operation of the at least one galvanic cell. The employed non-destructive testing method is preferably adapted to the physical parameter that is to be determined. Sound emission testing, acoustic resonance analysis, ultrasound testing, sonography, thermography, density testing, vibration testing, measurements of the geometry, measurement of the recovery after elastic deformation, temperature measurement, weighing and the measurement of electric current and electric voltage under load have proved to be particularly suitable in practice. Other non-destructive testing methods are also suitable, depending on the type of device or its operation.

Correct projecting lengths of the layers of the electrode stack, mechanical damage to the cells, corrosion of electrodes, discoloration or decomposition of materials are preferably ascertained by means of non-destructive testing. The undamaged state of the jacket of the galvanic cell is preferably ascertained by means of non-destructive testing.

Within the meaning of the invention, a test result is understood to mean the result of an examination. The test result is preferably present in the form of data, which particularly preferably can be processed electronically. In particular, an examination leads to a test result which can be picked up as electric current or as electric voltage. In particular, a test result is available as an at least mono-dimensional display which can be read off.

Within the meaning of the invention, a comparative value is understood to mean a value in respect of an, in particular, physical parameter which is related to a preferred range of this physical parameter in respect of the at least one galvanic cell. The comparative value preferably limits the desired range of a physical parameter in respect of a galvanic cell or the battery. In particular, a comparative value is related to a particularly preferred value for a physical parameter. In particular, the range in respect of a physical parameter that is possible during the operation of a galvanic cell or the battery is split up into a plurality of sub-ranges. These sub-ranges are also those which characterise a desirable or undesirable operating state of the galvanic cell or the battery. At least one comparative value is preferably stored, in particular permanently. A plurality of comparative values is preferably stored in respect of a range of a physical parameter. Comparative values are described below based on the temperature of a galvanic cell solely by way of example. The desired range of the temperature during operation is thus characterised by an upper and a lower limit. The temperature during the operation may also undesirably lie outside this preferred temperature range. As comparative values, a minimum temperature is therefore provided below the minimum operating temperature and a maximum temperature above the upper operating temperature. When one of the two aforementioned comparative values is overrun, the galvanic cell concerned is preferably switched off and electrically isolated. In addition, further measures to increase the safety of the galvanic cell can be taken. According to the invention, similar comparative values are also stored for other significant physical parameters. Within the meaning of invention, a comparative value is also understood to mean a characteristic as a function of time.

Within the meaning of the invention, the linking of a test result with a comparative value is understood to mean that differences and/or quotients are formed from these values. If a test result or a comparative value is present in the form of variations over time, linking preferably also includes filtering, the formation of mean values, a method for frequency analysis, the formation of error squares and extrapolation.

The underlying problem is also solved by a method for operating a battery with at least one galvanic cell. The battery comprises at least one electrode stack with at least two two-dimensionally extending layers, in particular at least an anode, a separator and a cathode. The at least one galvanic cell is examined at least from time to time, in particular when a predetermined operating state of the battery or the galvanic cell is present. In the examination, at least one functional parameter in respect of at least one two-dimensionally extending layer of the electrode stack is determined. The at least one functional parameter is then linked to at least a second comparative value.

Within the meaning of the invention, an electrode stack is understood to mean an arrangement which is used for the storage of energy in electrochemical form. An electrode stack is characterised by the narrow spatial arrangement of its components or layers. The electrode stack is preferably constituted prismatic. In the present case, an electrode stack is understood to mean the arrangement of at least two electrodes of differing polarity and an electrolyte disposed in between. The layers of an electrode stack are preferably constituted two-dimensionally extending and thin-walled and particularly preferably flexurally slack. A separator is preferably disposed at least partially between two electrodes of differing polarity. The sequence of the layers inside the electrode stack is preferably repeated several times. Some electrodes of the electrode stack are preferably connected to one another especially electrically, in particular connected in parallel. The layers are preferably coiled to form an electrode coil. The term “electrode stack” will also be used below for electrode coil.

Within the meaning of the invention, anode is understood to mean a device which takes up positively charged ions and electrodes during the charging of the respective galvanic cell. The anode is preferably constituted thin-walled, the thickness of the anode particularly preferably amounting to less than 5% of its largest edge length. The anode preferably comprises a metallic foil or a metallic network structure. The anode is preferably constituted essentially rectangular. The anode is preferably constituted flexurally slack.

Within the meaning of the invention, a cathode is understood to mean a device which takes up electrodes and positively charged ions during the discharge of the respective galvanic cell or during the delivery of the electric energy. The cathode is preferably constituted thin-walled, the thickness of the cathode particularly preferably amounting to less than 5% of its largest edge length. The cathode preferably comprises a metallic foil or a metallic network. The structure of a cathode preferably corresponds essentially to the structure of an anode of the electrode stack. The cathode is also provided for interaction with the anode and the electrolyte.

Within the meaning of the invention, a separator is also understood to mean an electrically insulating device, which separates an anode from a cathode and spaces the latter apart. A separator is preferably deposited as a layer on an adjacent anode and/or a cathode. The separator also at least partially absorbs an electrolyte, wherein the electrolyte preferably contains lithium ions. The electrolyte is in an electrochemically active connection with the adjacent layers of the electrode stack. The structure of the separator preferably corresponds essentially to the structure of an anode of the electrode stack. A separator is preferably constituted thin-walled, particularly preferably as a microporous film. The separator preferably extends at least in sections over a boundary edge of at least one electrode. Particularly preferably, the separator extends over all the boundary edges of adjacent electrodes.

Within the meaning of the invention, a functional parameter is understood to mean at least one property which permits information to be acquired about the operating state of a respective galvanic cell or a two-dimensionally extending layer of the electrode stack. A plurality of functional parameters is preferably used in combination to describe the state of a two-dimensionally extending layer of the electrode stack. In particular, properties important for the state of a layer of the electrode stack are preferably examined by the acquisition of a significant respective physical parameter. In particular, functional parameters are understood to mean the mechanical stability of the electrodes, in particular of the copper collectors, the presence of foreign particles from production, the formation of metallic dendrites, in particular of copper and/or lithium, discolorations of the electrodes, chemical composition of the electrodes, the content of specific ions, the corrosion of the electrodes or current-carrying layers of the electrode stack, the content of HF and H2O. Chemical and/or physical properties are preferably ascertained in respect of the individual layers of the electrode stack.

Within the meaning of the invention, a second comparative value is understood to mean a significant value in respect of a functional parameter.

According to the invention, the at least one galvanic cell or its components are examined, in particular in a predetermined operating state. Within the meaning of the invention, predetermined operating states are understood to mean various times during the existence of a galvanic cell or a battery. The galvanic cell or its components are preferably already examined during production, in particular during or after selected production procedures. Such test results are preferably stored. A galvanic cell or its component is preferably also examined after a longer period in storage before delivery and at regular intervals during the operation of the galvanic cell or the battery. The test results are stored.

During operation, a galvanic cell is subjected to charging and discharging processes, loads arising from high electric currents, overheating or undercooling, impacts and vibrations. These loads also lead to progressive ageing of the galvanic cell. By carrying out the repeated examinations of a galvanic cell or its components, incipient and/or accelerated ageing or damage to a galvanic cell can be detected in good time. When incipient and/or advanced damage is detected, measures can be taken to obtain operational reliability of the galvanic cell. In particular, an incipient failure of the electrical insulation between electrodes of differing polarity can be detected. In this way, an impending short-circuit in the electrode stack of the galvanic cell can be detected in good time. The tendency of the galvanic cell towards ignition on account of inadequate electrical insulation inside the electrode stack can also be countered. The underlying problem is therefore solved.

Preferred developments of the invention are described below.

The examination of the at least one galvanic cell preferably takes place using electromagnetic radiation. For this purpose, the galvanic cell to be examined is irradiated electromagnetically along at least one directional vector. The electromagnetic radiation preferably has wavelengths below 10 m, particularly preferably below 10⁻⁴ m. The wavelength is preferably less than 10⁻¹², so that the electromagnetic radiation is more in the nature of particles. After the interaction with the galvanic cell, the electromagnetic radiation is picked up by a detector at an angle of incidence typical for the wavelength and the geometry or materials of the galvanic cell. The detector is also adapted to the wavelength of the electromagnetic radiation to be received. Various technical devices, but also the naked eye, can be considered as detectors. In particular, the electromagnetic radiation can be guided by means of devices for beam guidance. Such devices also include those which can bundle, scatter, block off, deflect and/or reflect electromagnetic radiation. The detector preferably delivers an electronically processable signal. In particular, infrared radiation, visible light, X-radiation, gamma radiation, but also particle beams (alpha radiation, beta-minus radiation, beta-plus radiation) have proved to be useful in practice. The at least one galvanic cell is preferably examined also by means of computer tomography or magnetic resonance tomography. The electromagnetic irradiation of the at least one galvanic cell preferably takes place along different directional vectors. Particularly preferably, at least two of these directional vectors are at right angles to one another. The results of examinations with electromagnetic irradiation along at least two different directional vectors are preferably linked to one another, in particular computationally. The electromagnetic irradiation preferably takes place in a pulsed manner or with an intensity variable over time. The electromagnetic radiation preferably penetrates through the jacket and provides information about its contents, in particular the layers of the electrode stack. The galvanic cell is preferably at least partially heated or irradiated by the electromagnetic radiation.

To advantage, the examination results together with the time of the respective examination are stored. When required, a progress log is preferably produced from these stored data. This progress log is used in particular to assist the process of further development of a galvanic cell with respect to the materials used and the production processes.

To advantage, the results of the examinations are stored together with an identification of the examined galvanic cell of a battery. A cell-specific progress log preferably thus arises, which when required can also be used to improve the design of a galvanic cell. In the course of servicing work, the stored data are preferably read out and communicated to the manufacturer.

To advantage, the at least one galvanic cell is examined at different times, in particular at a predetermined time interval. These examinations are preferably evaluated taking account of the progress of time, in such a way that incipient and/or progressive ageing or damage to the galvanic cell is ascertained and detected. By using a defined computational rule, a future course of the concerned examination result as a function of time is preferably predicted. In the presence of a defined actual and/or predicted course of a physical parameter, a warning message is preferably initiated. The latter is preferably displayed to a user of the vehicle and/or to servicing personnel. An, in particular, computer-assisted evaluation in respect of chemical and/or physical data of the galvanic cell to be tested preferably takes place. Such chemical and/or physical data are, in particular:
calligraphy, i.e. correct arrangement and projecting lengths between electrodes (anodes/cathodes) and separator or separators, in particular in the case of a stacked arrangement;
chemical and/or physical stability of the collectors, in particular of copper collectors;
production-related influence of foreign particles and/or faults present in materials;
formation or development of copper dendrites;
formation or development of lithium dendrites;
mechanical and/or thermal deterioration or damage, including discoloration, of the cell or individual elements and/or components to be tested, such as particular individual layers of the electrode stack; a particular aspect here is, for example, the inspection of ceramic separators, in particular with regard to mechanical damage such as cracks or ruptures;
chemical composition of the electrodes and/or the separators;
density of the electrodes and/or separators, optionally also of the electrolyte;
ion content, in particular of the electrolyte;
liberation and/or dissolution phenomena from materials;
corrosion of conductors (contact elements) and/or of the jacket, possibly also of the housing; and
HF content or concentration (hydrofluoric acid) and H2O content or concentration.

Furthermore, critical states of a degradation can be detected, such as in particular:
incipient lithium deposition on carbon components;
incipient electrolyte decomposition; and
incipient or complete delithiation of a cathode.

In addition, electric short-circuits of the most varied kind can be detected.

To advantage, an examination result is displayed graphically to a person in charge of production of the galvanic cell, servicing personnel and/or a user of the device according to the invention. The at least one examination result, i.e. test result, a functional parameter or a physical parameter, is preferably displayed graphically in relation to a comparative value and/or a desired state. The graphic representation preferably takes place on a display screen or monitor. Limiting values, desired courses, desired geometries are preferably displayed. In particular, the at least one examination result from a non-destructive test using electromagnetic radiation is displayed graphically. To advantage, the person making the observation acquires within a short time an impression of the state of the at least one galvanic cell. An automated fault analysis based on the examination is preferably carried out on the galvanic cell to be tested. This automated fault analysis preferably takes place in a computer-supported manner, e.g. on the basis of stored computational rules, which in particular reproduce permitted safety operating windows. If chemically and/or physically critical data or values are detected, which could indicate critical and/or dangerous operating states of the galvanic cell to be tested, a fault message is displayed in order to avoid future damage and to ensure safety. An examining person preferably releases a galvanic cell with an acknowledgement after the examination. The fault message and/or the acknowledgement is preferably stored, particularly preferably with a value which is representative of the time of the examination and/or of the person carrying out the examination.

To advantage, the at least one galvanic cell is removed from the battery, in particular in the case of advanced ageing and/or incipient failure especially of the electrical insulation between electrodes of differing polarity of the electrode stack. The galvanic cell concerned is preferably replaced by a less hazardous galvanic cell. A galvanic cell to be removed is preferably removed in the course of servicing work. A galvanic cell to be removed is preferably electrically isolated before the removal. A galvanic cell to be removed is preferably discharged before removal.

To advantage, there are assigned to the battery further devices which assist the performance of a method according to the invention. The at least one measuring device is preferably also used to detect at least one functional parameter or one physical parameter which provides information concerning the state of the at least one galvanic cell. When required, the at least one measuring device is preferably actuated by the control device in order to detect a measured value. The at least one measuring device of the control device preferably makes a measured value available. A measuring device preferably comprises a plurality of measuring sensors, which in particular are assigned to different galvanic cells. Data concerning measured values and time-related courses of measured values, in particular for preparing a progress log, are preferably stored in the memory device. The at least one measuring device preferably comprises a detector for electromagnetic radiation, in particular for X-radiation, infrared radiation. The at least one measuring device preferably comprises a detector for sound waves, in particular for ultrasound waves.

The electrode stack of the at least one galvanic cell is preferably constituted with a separator, which comprises a substance-permeable carrier, preferably partially substance-permeable, i.e. essentially permeable in respect of at least one material and essentially impermeable in respect of at least another material. The carrier is coated on at least one side with an inorganic material. As a substance-permeable carrier, use is preferably made of an organic material, which is preferably constituted as a non-woven fabric. The organic material, preferably a polymer and particularly preferably polyethylene terephthalate (PET), is coated with an inorganic ion-conducting material, which is ion-conducting preferably in a temperature range from −40° C. to 200° C. The inorganic, ion-conducting material preferably comprises at least one compound from the group of oxides, phosphates, sulphates, titanates, silicates, aluminosilicates with at least one of the elements Zr, Al, Li, particularly preferably zirconium oxide. The inorganic, ion-conducting material preferably comprises particles with a maximum diameter of less than 100 nm. Such a separator is marketed for example under the trade name “Separion” from Evonik AG in Germany.

The device for operating the method is preferably assigned to the supplied drive and/or the vehicle. The performance of a method according to the invention is thus also possible especially during the use of the supplied drive. A device for operating the method is preferably installed at a location at which servicing work is carried out.

Further advantages, features and possible applications of the present invention emerge from the following description in connection with the figures. In the figures:

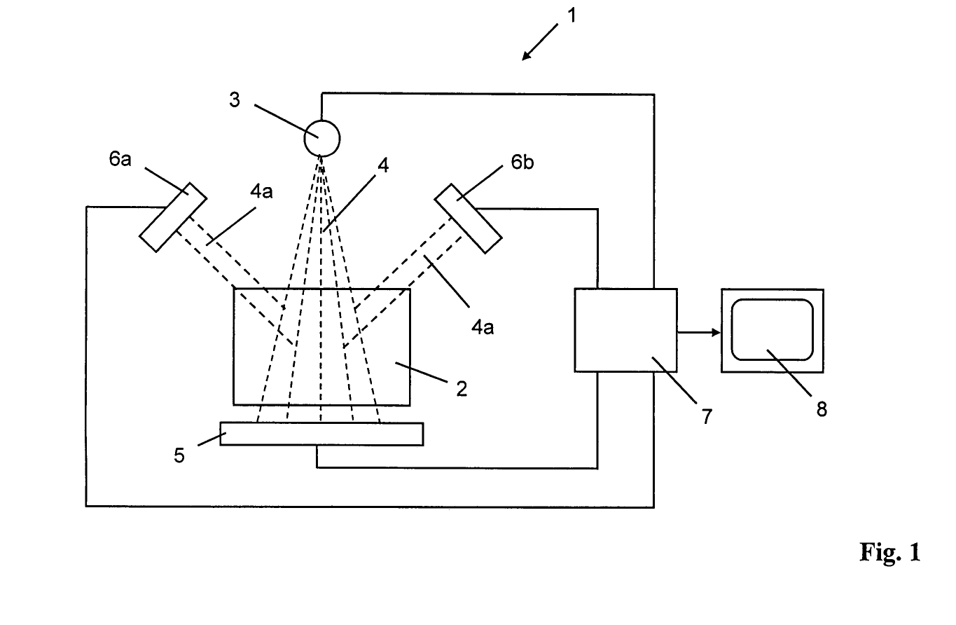

FIG. 1 shows an embodiment of a device according to the invention in a schematic diagram; and

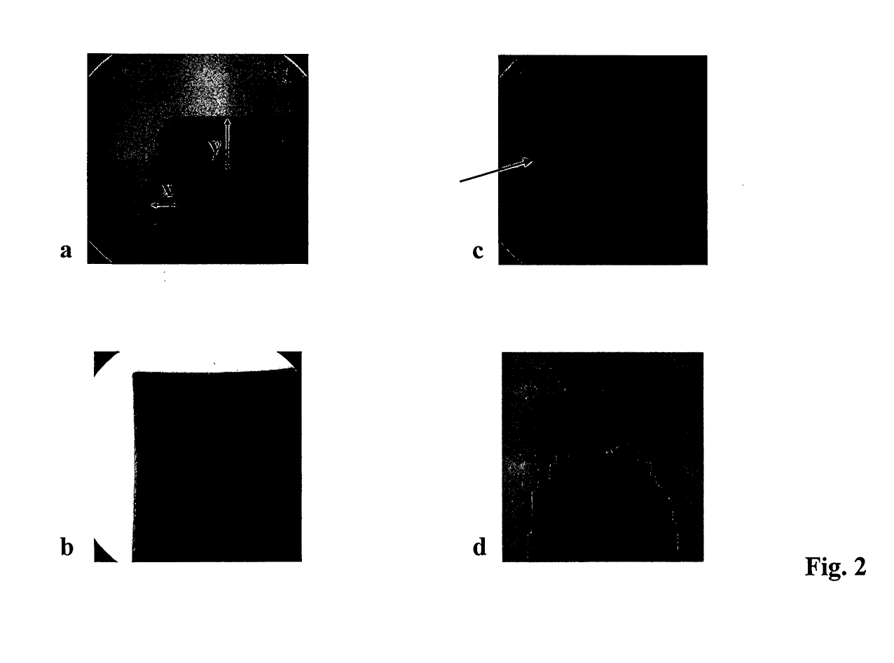

FIG. 2 shows four different photographs of a battery to be tested which are based on an x-ray technology.

FIG. 1 shows a test set-up, designated overall by 1, for the non-destructive testing of galvanic cells. A galvanic cell to be tested is designated by 2. Depending on the embodiment, device 1 can test or examine a single galvanic cell 2 or a plurality of galvanic cells 2.

Testing device 1 comprises a beam source 3. Alternatively, testing device 1 can also comprise a plurality of beam sources 3, which are disposed in different positions around galvanic cell 2 to be tested. Beam source 3 is, for example, an X-ray emitter. This beam source 3 emits rays 4, these being for example X-rays which penetrate galvanic cell 2 to the tested and are detected by sensor 5, this being for example an X-ray sensor. Rays 4 are in particular orientated parallel with one another.

Depending on the type of beam source 3, rays 4 emitted by this beam source 3 penetrate galvanic cell 2 to be tested and/or are reflected or at least partially reflected at or in the latter. Reference number 4a designates reflected rays, which are detected by corresponding sensors 6a and 6b.

A computer 7 is included in order to control beam source 3 and to process the sensor signals of sensors 5, 6a and 6b. Said computer calculates from the sensor signals an image, a sequence of images to represent the interior of galvanic cell 2 to be tested that is not visible with the naked eye. This result can be displayed on a monitor 8, on which a trained specialist can examine galvanic cell 2 to be tested from various aspects and can evaluate the examination result.

An automated fault analysis can also be carried out by means of computer 7. This automated fault analysis takes place for example with the aid of algorithms stored by software or for example by means of an image comparison with stored ideal or nominal images. If a defective state or an otherwise critical state is detected on the galvanic cell to be tested, a fault display can take place on monitor 8, the specifically detected fault then being able to be read out. This thus makes it possible for galvanic cell 2 to be tested to be withdrawn, replaced or repaired.

Moreover, it is possible by means of computer 7 also to determine further relevant data concerning galvanic cell 2 to be tested, such as in particular a residual service life or various performance values. These data can also be read off on monitor 8.

Diverging from the example of embodiment shown, testing device 1 can also comprise a plurality of beam sources 3 of different kinds. Thus, for example, an X-ray emitter can be combined with an ultrasound beam source. In this case, corresponding sensors also have to be provided.

Furthermore, there is the possibility of detecting with suitable sensors inherent radiation of the galvanic cell to be tested, e.g. thermal radiation or a magnetic field, and of evaluating the same by means of computer 7. In this case, a beam source 3 would not necessarily be required. Such inherent radiation of galvanic cell 2 to be tested can additionally be detected in the embodiment explained above.

FIG. 2 shows four different photographs or images a to d of a galvanic cell 2 to the tested, which were taken on a testing device 1 according to FIG. 1 based on X-ray technology. The images show an electrode stack (see above embodiments in this regard), wherein the electrodes and separators are constituted as stack leaves, grouped and enclosed, and combined to form a stack.

The correct arrangement of the electrodes and separators of galvanic cell 2 to be tested can be examined in the represented images, which takes place for example manually by a trained specialist. In this regard, there is the possibility of a measurement of the images on monitor 8, for which purpose special tools, for example, are made available.

Partial figure a shows a two-dimensional alignment error (x, y) of an anode relative to a cathode, which in a correct arrangement should be aligned in the stack direction, i.e. should lie essentially exactly one upon the other, as is shown in partial figure b. Such an alignment error can have a very adverse effect on a performance value of the galvanic cell to be tested and can also represent a considerable risk to safety.

Partial figure c shows a tilting of the stack of electrodes and separators, this being indicated by an arrow. Such tilting can also have a very adverse effect on a performance value of the galvanic cell to be tested and can also represent a considerable risk to safety.

Partial figure d shows the photographed orientation of an upper layer.

Such photographs or images can of course also be produced in the case of circular-cylindrical coil-type cells or cells with another cell structure, wherein it may be necessary here to examine other arrangement criteria.

The invention can be used in particular in the case of galvanic cells with lead, nickel-metal hydride, lithium, lithium ions. The application in the case of lithium-ion cells is preferably provided for, especially in the car sector.

A further aspect of the invention consists in irradiating or penetrating by radiation galvanic cell 2 to be tested in different operating states. Chemical and/or physical data of galvanic cell 2 to the tested can be detected and examined here, which possibly occur only in the given operating state and possibly cannot otherwise be detected or can be so only with limitations. The detected data can then indicate, for example, possible fault-related overheating problems, which for example could trigger a so-called “thermal runaway”. A “thermal runaway” is understood to mean a self-intensifying temperature rise of galvanic cell 2, which can lead to spontaneous ignition and possibly to explosion of galvanic cell 2.

1.-10. (canceled)

11. A method for operating a battery with at least one galvanic cell, wherein the at least one galvanic cell is subjected at least temporarily to an examination,
wherein
the examination of the at least one galvanic cell takes place with a non-destructive testing method using electromagnetic radiation,
that at least one test result is ascertained with the examination, and that the at least one test result is linked to at least a first comparative value.

12. The method according to claim 11, wherein the examination of the at least one galvanic cell takes place in a predetermined operating state of the battery or the galvanic cell.

13. The method according to claim 12, wherein at least one test result is ascertained with the examination, and that the at least one test result is linked to at least a first comparative value.

14. The method according to claim 13, wherein the examination of the at least one galvanic cell takes place by irradiation with electromagnetic radiation, wherein the at least one galvanic cell is irradiated in at least one direction.

15. The method according to claim 14, wherein
at least one galvanic cell comprises an electrode stack with at least two two-dimensionally extending layers, in particular at least an anode, a separator and a cathode, and that, in the examination, at least one functional parameter in respect of at least one two-dimensionally extending layer of the electrode stack is determined, and that the at least one functional parameter is linked to at least a second comparative value.

16. The method according to claim 15, wherein the at least one test result and/or the at least one functional parameter is stored together with a value which is representative of the time of the examination.

17. The method according to claim 16, wherein the at least one test result and/or the at least one functional parameter is stored together with a value which is representative of the examined galvanic cell of the battery.

18. The method according to claim 17, wherein the at least one galvanic cell is subjected to a first examination and, particularly at after a predetermined time interval has elapsed, to at least a second examination,
and that at least one test result or at least one functional parameter of the at least two examinations are linked together.

19. The method according to claim 18, wherein the at least one test result and/or the at least one functional parameter is displayed graphically.

20. The method according to claim 19, wherein the at least one galvanic cell is removed from the battery when predetermined conditions are present.

21. A battery with at least one galvanic cell, which comprises an electrode stack, and which is equipped for performing a method according to at least one of the preceding claims, wherein there are assigned to the battery at least:
a measuring device which is provided to detect at least one measured value in respect of the at least one galvanic cell or its electrode stack under predetermined conditions,
a memory device which is provided to store at least one measured value, in particular together with a value which is representative of the time of the measurement,
and/or a control device which is provided to control the at least one measuring device for detecting a measured value.

22. The battery according to claim 21, wherein the electrode stack comprises at least one separator, for performing a method according to claim 1, wherein the separator of the at least one galvanic cell preferably comprises a substance-permeable carrier, partially substance-permeable,
wherein the carrier is coated on at least one side with an inorganic material,
wherein, as a substance-permeable carrier, use is made of an organic material, which is preferably constituted as a non-woven fabric,
wherein the organic material comprises a polymer and particularly preferably polyethylene terephthalate (PET),
wherein the organic material is coated with an inorganic ion-conducting material, which is ion-conducting preferably in a temperature range from −40° C. to 200° C.,
wherein the inorganic, ion-conducting material is at least one compound from the group of oxides, phosphates, sulphates, titanates, silicates, aluminosilicates of at least one of the elements Zr, Al, Li, preferably zirconium oxide
and wherein the inorganic, ion-conducting material comprises particles with a maximum diameter of less than 100 nm.
